(19) United States
(12) Patent Application Publication
(10) Pub. No.: US 2011/0212016 A1
(43) Pub. Date: Sep. 1, 2011

(54) Supported Catalysts for Synthesizing Carbon Nanotubes, Method for Preparing the Same, and Carbon Nanotubes Made Using the Same

(75) Inventors: Yun Tack LEE, Seoul-si (KR); Byeong Yeol KIM, Sungnam-si (KR); Seung Yong BAE, Gunpo-si (KR); Young Kyu CHANG, Gunpo-si (KR); Young Sil LEE, Gunpo-si (KR)

(73) Assignee: CHEIL INDUSTRIES INC., Gumi-si (KR)

(21) Appl. No.: 13/091,267

(22) Filed: Apr. 21, 2011

Related U.S. Application Data
(63) Continuation-in-part of application No. PCT/KR2008/007781, filed on Dec. 30, 2008.

(30) Foreign Application Priority Data
Oct. 23, 2008 (KR) 10-2008-0104349

(51) Int. Cl. D01F 9/12; B01J 31/06; B01J 31/26; B01J 35/08; B01J 35/02; B01J 37/04; B01J 37/08; B82Y 40/00

(52) U.S. Cl. 423/447.3; 502/159; 423/447.1; 977/842; 977/843

(57) ABSTRACT

The present invention provides a supported catalyst for synthesizing carbon nanotubes. The supported catalyst includes a metal catalyst supported on a supporting body and a water-soluble polymer, and has an average diameter of about 30 to about 100 μm.

### CROSS-REFERENCE TO RELATED APPLICATIONS

This application is a continuation-in-part of International Application No. PCT/KR2008/007781, filed Dec. 30, 2008, pending, which designates the U.S., published as WO 2010/047439, and is incorporated herein by reference in its entirety, and claims priority there from under 35 USC Section 120. This application also claims priority under 35 USC Section 119 from Korean Patent Application No. 10-2008-0104349, filed Oct. 23, 2008, in the Korean Intellectual Property Office, the entire disclosure of which is also incorporated herein by reference.

### FIELD OF THE INVENTION

The present invention relates to a supported catalyst for synthesizing carbon nanotubes, a method for making the same, and carbon nanotubes made using the same.

### BACKGROUND OF THE INVENTION

Carbon nanotubes discovered by Iijima in 1991 have hexagon beehive-like structures connecting one carbon atom thereof with three other neighboring carbon atoms, and the hexagon structures thereof are repeated and rolled into a cylinder or a tube form. Carbon nanotubes are classified as single-walled, double-walled, or multi-walled carbon nanotubes based on the number of walls.

Carbon nanotubes have excellent mechanical properties, electrical selectivities, field emission properties, and hydrogen storage properties, among other properties. Further, carbon nanotubes can be used in polymer composites. Accordingly, since their discovery, carbon nanotubes have been the subject of numerous publications and research efforts focused on the development of industrial and commercial applications of the same.

Carbon nanotubes can be synthesized by arc discharge, laser ablation, and chemical vapor deposition. These various synthetic methods, however, can be expensive and further can be limited with regard to the synthesis of carbon nanotubes in high yields and with high purity.

In addition, recent studies have focused on methods of synthesizing large quantities of carbon nanotubes. Among the various synthetic methods, thermal chemical vapor deposition can provide large-scale production using simple equipment.

Thermal chemical vapor deposition can be conducted using a fixed bed reactor or a fluidized bed reactor. The fixed bed reactor is not largely influenced by relative shapes or sizes of metal supporting bodies, but it cannot produce large quantities of carbon nanotubes due to space limitations inside the reactor. The fluidized bed reactor can synthesize larger quantities of carbon nanotubes more easily than the fixed bed reactor because the reactor stands up vertically.

Because fluidized bed reactors can continuously produce larger quantities of carbon nanotubes as compared to fixed bed reactors, many studies have focused on fluidized bed reactors. However, fluidized bed reactors require metal supporting bodies with uniform shapes and sizes so as to float the metal supporting bodies evenly (uniformly). Accordingly, there is a need for a method of synthesizing a catalyst having a metal supporting body with a uniform shape and size.

### SUMMARY OF THE INVENTION

To solve this problem, the present inventors have developed a supported catalyst for synthesizing carbon nanotubes. The supported catalyst can have a uniform shape and size, for example, can have a uniform spherical shape and uniform size (such as a uniform diameter). Accordingly, the supported catalyst of the invention can be suitable for use in a fluidized bed reactor (which requires catalyst floatability) as well as a fixed bed reactor. The supported catalyst of the invention further can be readily mass produced in large quantities and can provide time and cost savings. The supported catalyst of the invention can further have high production efficiency, selectivity, and purity.

The present invention further provides a method of making the supported catalyst. The method of the invention can provide a supported catalyst having a uniform spherical shape and uniform size by spray-drying a catalytic solution comprising a water-soluble polymer as a binder.

The present invention also provides carbon nanotubes and methods of making the same using the supported catalyst. The carbon nanotubes can exhibit improved productivity and uniformity and can be prepared in a fixed bed reactor or a fluidized bed reactor using the supported catalysts.

Other aspects, features and advantages of the present invention will be apparent from the ensuing disclosure and appended claims.

The supported catalyst of the present invention for synthesizing carbon nanotubes includes a metal catalyst on a supporting body and a water soluble polymer. Examples of the metal catalyst include without limitation Fe, Co, Ni, alloys thereof, and combinations thereof. Examples of the supporting body include without limitation alumina (aluminum oxide), magnesium oxide, silica (silicon dioxide), and combinations thereof. The supported catalyst of the invention has a spherical shape and an average diameter of about 30 to about 100 μm.

In one exemplary embodiment of the present invention, the supported catalyst further comprises a molybdenum activator.

In one exemplary embodiment of the present invention, the supported catalyst may have a molar ratio as follows:

Fe, Co, and Ni:Mo:Al, Mg and Si=x:y:z

wherein 1≦x≦10, 0≦y≦5 and 2≦z≦70.

In another exemplary embodiment, the supported catalyst may have a molar ratio as follows:

Fe:Co:Mo:Al=x₁:x₂:y:z

wherein 1≦x≦20, 5≦x₂≦30, 0.1≦y≦10 and 50≦z≦300.

The supported catalyst is empty or hollow inside.

The present invention also provides a process of synthesizing the supported catalyst. The process comprises preparing a mixed catalytic solution by mixing a water-soluble polymer and an aqueous catalytic solution which comprises metal catalyst and a supporting body; preparing a catalyst powder by spray-drying the mixed catalytic solution; and firing the catalyst powder to form the supported catalyst.

In exemplary embodiments, the metal catalyst may include Fe(NO₃)₃, Co(NO₃)₂, Ni(NO₃)₂, Fe(OAc)₂, Co(OAc)₂, Ni(OAc)₂, or a combination thereof.

The supporting body may include aluminum nitrate, magnesium nitrate, silica (silicon dioxide), or a combination thereof.

The metal catalyst and the supporting body can be in an aqueous phase.

Examples of the water-soluble polymer may include without limitation urea based polymer, melamine based polymer, phenol based polymer, unsaturated polyester based polymer, epoxy based polymer, resorcinol based polymer, acetic acid vinyl based polymer, poly vinyl alcohol based polymer, vinyl chloride based polymer, polyvinylacetal based polymer, acrylic based polymer, saturated polyester based polymer, polyamide based polymer, polyethylene based polymer, vinyl based polymer, starch, glue, gelatin, albumin, casein, dextrin, acid modified starch, cellulose, and the like, and combinations thereof.

In exemplary embodiments, the water-soluble polymer may be used in amount of about 1 to about 50% by weight based on the total weight of the solids in the aqueous catalytic solution.

The spray-drying may be performed at a temperature of about 200 to about 300° C., at a disc-revolution speed of about 5,000 to about 20,000 rpm, and a solution injection rate of about 15 to about 100 mL/min.

The firing may be performed at a temperature of about 350 to about 1100° C. The supported catalyst prepared by the above process has a spherical shape.

The present invention further provides carbon nanotubes manufactured using the supported catalyst and methods of making the same. The carbon nanotubes may be synthesized in a fluidized bed reactor or in a fixed bed reactor. In exemplary embodiments, the carbon nanotubes may be prepared by injecting a carbon nanotube precursor material, such as a hydrocarbon gas, into a reactor under conditions sufficient to produce the carbon nanotubes, for example, at a temperature of about 650 to about 1100° C., in the presence of the supported catalyst.

### BRIEF DESCRIPTION OF THE DRAWINGS

FIGS. 1(a) and (b) are schematic views of a supported catalyst for synthesizing carbon nanotubes in accordance with exemplary embodiments of the present invention.

FIG. 2(a) is a transmission electron microscope (TEM) image of spray-dried particles prepared in Example 1, and FIG. 2(b) is a transmission electron microscope (TEM) image of the supported catalysts prepared in Example 1.

FIGS. 3(a) and (b) are transmission electron microscope (TEM) images of carbon nanotubes prepared in Example 1.

FIG. 4 is a transmission electron microscope (TEM) image of carbon nanotubes prepared using the supported catalyst of Example 2.

FIG. 5 is a transmission electron microscope (TEM) image of supported catalysts prepared in Comparative Example 1.

### DETAILED DESCRIPTION OF THE INVENTION

The present invention will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

Supported Catalyst

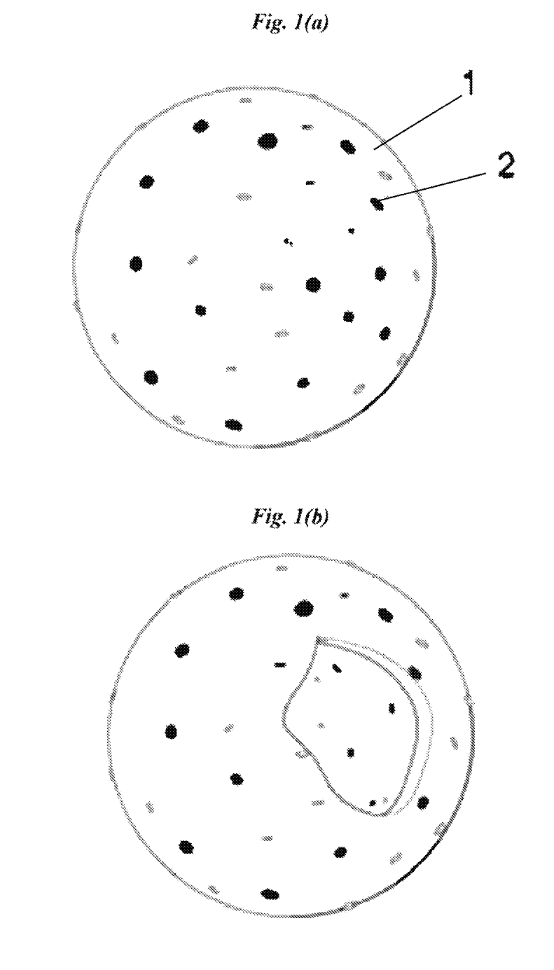

The present invention provides a supported catalyst for synthesizing carbon nanotubes. FIG. 1(a) is a schematic view of a supported catalyst for synthesizing carbon nanotubes of the present invention. The supported catalyst includes metal catalysts (2) supported on a supporting body (1) and a water soluble polymer. In exemplary embodiments, the metal catalysts (2) are in the form of a plurality of metal catalyst particles distributed across an outer surface of the supporting body (1) of the supported catalyst, such as illustrated in FIG. 1(a).

The supported catalyst has a substantially spherical shape. As used herein, reference to the spherical shape of the supported catalyst includes an oval shape as well as a substantially spherical shape as illustrated in FIG. 1(a), as observed by a transmission electron microscope (TEM) at 500 magnification. In exemplary embodiments, an oval form may have about 0 to about 0.2 flattening rate.

The supporting body (1) may form pores on its surface as illustrated in FIG. 1(b). The surface of the supporting body (1) may also be uneven (that is, the surface is not necessarily perfectly smooth) and further may include projections formed on the surface of the supported catalyst of the present invention.

Accordingly, the skilled artisan will appreciate that some irregularities in the supported catalyst shape and/or supported catalyst surface can be present without falling outside of the scope of the claimed invention. For example, reference to a spherical or oval shape does not limit the invention to a precise or exact spherical or oval shape and the skilled artisan will appreciate that the invention can include some variances so long as the supported catalyst has a generally spherical or oval shape

The supported catalyst has a hollow structure such that the interior of the supported catalyst is empty. The metal catalyst (2) can also be distributed in the hollow interior, for example, on the inner surface of the hollow spherical supporting body, as well as on the outer surface of the supporting body, as illustrated schematically in FIG. 1(b).

Examples of the metal catalyst may include without limitation, Fe, Co, Ni, and the like, as well as alloys thereof, and combinations thereof.

Examples of the supporting body may include without limitation alumina (aluminum oxide), magnesium oxide, silica (silicon dioxide), and the like, and combinations thereof.

In another exemplary embodiment, the supported catalyst can further include an activator. As a non-limiting example, a molybdenum activator such as ammonium molybdate tetrahydrate can be used. The activator can prevent agglomeration of the catalyst during a firing step at high temperatures. In another exemplary embodiment, citric acid may be used as an activator.

In the present invention, the water-soluble polymer is used as a binder to maintain the spherical shape of the supported catalyst. Stated differently, the water-soluble polymer can prevent the catalyst particles or powder from breaking when preparing the supported catalyst and thereby can maintain the spherical shape of the supported catalyst.

The water-soluble polymer can be any suitable polymer known in the art that can be dissolved in water. Further, the water-soluble polymer may have adhesive properties. Examples of the water-soluble polymer may include without limitation urea based polymers, melamine based polymers, phenol based polymers, unsaturated polyester based polymers, epoxy based polymers, resorcinol based polymers, acetic acid vinyl based polymers, poly vinyl alcohol based polymers, vinyl chloride based polymers, polyvinylacetal based polymers, acrylic based polymers, saturated polyester based polymers, polyamide based polymers, polyethylene based polymers, vinyl based polymers, starches, glues, gelatins, albumins, caseins, dextrins, acid modified starches, celluloses, and the like, and combinations thereof.

Non-water soluble polymers such as but not limited to polyethylene may also be added and mixed into the aqueous catalytic solution. The non-water soluble polymer may be used alone or in combination with another non-water soluble polymer.

In exemplary embodiments, the water-soluble polymer may be added in amount of about 1 to about 50% by weight, for example about 15 to about 25% by weight, as another example about 5 to about 20% by weight, and as yet another example about 20 to about 45% by weight, based on the total weight of solids comprising the metal catalysts, the supporting body, the water-soluble polymer, and optionally the activator.

In some embodiments, the water-soluble polymer may be used in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50% by weight. Further, according to some embodiments of the present invention, the amount of the water-soluble polymer may range from about any of the foregoing amounts to about any other of the foregoing amounts.

The supported catalyst of the present invention has an average diameter of about 30 to about 100 μm, for example about 40 to about 95 μm, and as another example about 50 to about 90 μm. In an exemplary embodiment, the supported catalyst of the present invention may have an average diameter of about 35 to about 50 μm. In another exemplary embodiment, the supported catalyst of the present invention may have an average diameter of about 55 to about 80 μm or about 75 to about 100 μm.

In some embodiments, the supported catalyst can have an average diameter of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100 μm. Further, according to some embodiments of the present invention, the average diameter of the supported catalyst can be in a range from about any of the foregoing to about any other of the foregoing.

In an exemplary embodiment of the present invention, the supported catalyst may have a molar ratio as follows:

Fe, Co, and Ni:Mo:Al, Mg and Si=x:y:z

wherein 1≦x≦10, 0≦y≦5 and 2≦z≦70.

In another exemplary embodiment, the supported catalyst may have a molar ratio as follows:

Fe:Co:Mo:Al=x₁:x₂:y:z

wherein 1≦x₁≦20, 5≦x₂≦30, 0.1≦y≦10 and 50≦z≦300.

The Method of Making the Supported Catalyst

The present invention also provides a method of making the supported catalyst. The method of making the supported catalyst comprises: adding a water-soluble polymer to an aqueous catalytic solution including metal catalyst and a supporting body to prepare a mixed catalytic solution; spray-drying the mixed catalytic solution to prepare a catalyst powder, which can have a spherical shape; and firing the catalyst powder to form the supported catalyst, which can also have a spherical shape.

In exemplary embodiments, the metal catalyst may include Fe(NO₃)₃, Co(NO₃)₂, Ni(NO₃)₂, Fe(OAc)₂, Co(OAc)₂, Ni(OAc)₂, and the like, and combinations thereof. In exemplary embodiments, the metal catalyst may be in the form of a hydrate. For example, the metal catalyst may be used in the form of iron (III) nitrate nonahydrate, cobalt nitrate nonahydrate, or a combination thereof.

Examples of the supporting body may include without limitation aluminum nitrate, magnesium nitrate, silica (silicon dioxide), and the like, and combinations thereof. In exemplary embodiments, aluminum nitrate nonahydrate may be used.

The metal catalyst and the supporting body can be dissolved into water and mixed to form the aqueous catalytic solution.

In another exemplary embodiment, the aqueous catalytic solution can further include an activator. As a non-limiting example, a molybdenum activator such as ammonium molybdate tetrahydrate can be used. The activator can prevent agglomeration of the catalyst during a firing or sintering step at high temperatures. In another exemplary embodiment, citric acid may be used as an activator.

The metal catalyst and supporting body, and optionally molybdenum based or other activator, can be mixed and completely dissolved in the aqueous catalytic solution.

The mixed catalytic solution can be prepared by adding and dissolving a water-soluble polymer into the aqueous catalytic solution containing the metal catalysts and the supporting bodies. The mixed catalytic solution is spray-dried to prepare a catalyst powder, which can have a spherical shape. Spray-dried catalyst powder or particles may be easily broken during heat treatment such as sintering or firing after spray-drying. In the present invention, however, the water-soluble polymer is used as a binder to maintain the spherical shape of the catalyst powder. Stated differently, the water-soluble polymer is added to the aqueous catalytic solution to prevent the catalyst particles or powder from breaking and to maintain the spherical shape of the spray-dried catalyst particles or powder so that the resultant supported catalyst also has a spherical shape.

The water-soluble polymer can be any suitable polymer known in the art that can be dissolved in water. Further, the water-soluble polymer may have adhesive properties. Examples of the water-soluble polymer may include without limitation urea based polymers, melamine based polymers, phenol based polymers, unsaturated polyester based polymers, epoxy based polymers, resorcinol based polymers, acetic acid vinyl based polymers, poly vinyl alcohol based polymers, vinyl chloride based polymers, polyvinylacetal based polymers, acrylic based polymers, saturated polyester based polymers, polyamide based polymers, polyethylene based polymers, vinyl based polymers, starches, glues, gelatins, albumins, caseins, dextrins, acid modified starches, celluloses, and the like, and combinations thereof.

Non-water soluble polymers such as but not limited to polyethylene may also be added and mixed into the aqueous catalytic solution. The non-water soluble polymer may be used alone or in combination with another non-water soluble polymer.

In exemplary embodiments, the water-soluble polymer may be added in amount of about 1 to about 50% by weight, for example about 15 to about 25% by weight, as another example about 5 to about 20% by weight, and as yet another example about 20 to about 45% by weight, based on the total solids in the aqueous catalytic solution. In some embodiments, the water-soluble polymer may be used in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50% by weight. Further, according to some embodiments of the present invention, the amount of the water-soluble polymer may range from about any of the foregoing amounts to about any other of the foregoing amounts.

The mixed catalytic solution including the water-soluble polymer dissolved therein is formed into spherical particles using a spray-drying method.

The spray-drying method can readily produce a large quantity of metal supporting bodies having a uniform spherical shape and size. The spray-drying method sprays a fluid-state supply of a precursor material (the mixed catalytic solution) into a hot drying gas so that drying happens nearly instantly. Dryness happens quickly because the fluid-state supply is sprayed by an atomizer, which can substantially increase the surface area of the product.

Spray-drying equipment, such as the atomizer, as well as solution density, spray amount, and rotation rate of the atomizer disc, can influence the size of a catalyst powder or particles. In exemplary embodiments, the spray-drying may be performed at a temperature of about 200 to about 300° C., for example about 270 to about 300° C.

There are two types of spraying methods, nozzle-type and disc-type which forms and sprays the drops of a solution by disc rotation. In an exemplary embodiment, the supported catalyst is formed using a disc-type spraying method, which can provide more uniform (even) particle shapes and/or sizes. The particle size and distribution can be controlled by various factors such as disc rotation rate, solution injection rate (solution inlet capacity), solution density and the like. In exemplary embodiments of the present invention, the disc rotation rate may be about 5,000 to about 20,000 rpm, and the solution injection rate (inlet capacity) may be about 15 to about 100 mL/min. In another exemplary embodiment, the disc rotation rate may be about 10,000 to about 18,000 rpm, about 12,000 to about 19,000 rpm or about 5,000 to about 9,000 rpm, and the solution injection rate of the spray-drying method may be about 15 to about 60 ml/min, about 50 to about 75 ml/min or about 80 to about 100 ml/min.

In some embodiments, the spray-drying method may be carried out at a disc rotating speed of about 5000, 6000, 7000, 8000, 9000, 10,000, 11,000, 12,000, 13,000, 14,000, 15,000, 16,000, 17,000, 18,000, 19,000, or 20,000 rpm. Further, according to some embodiments of the present invention, the spray-drying method may be carried out at a disc rotating speed of about any of the foregoing speeds to about any other of the foregoing speeds.

In some embodiments, the spray-drying method may be carried out at a solution injection rate of about 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 ml/min. Further, according to some embodiments of the present invention, the spray-drying method may be carried out at a solution injection rate of about any of the foregoing rates to about any other of the foregoing rates.

The catalyst powder or particles synthesized by spray-drying are heat-treated through firing or sintering. The metal catalyst can be crystallized by the firing process.

The diameter and other properties of carbon nanotubes prepared using the supported catalyst can vary depending on temperature and firing time of the catalyst powder. In exemplary embodiments, the firing process may be performed at a temperature of about 500 to about 800° C., for example about 450 to about 900° C., and as another example about 350 to about 1100° C. In another exemplary embodiment, the firing process may be performed at a temperature of about 350 to about 500° C., about 550 to about 700° C., about 650 to about 900° C. or about 750 to about 1100° C. The firing process may be performed for a period of about 15 minutes to about 3 hours, for example about 30 minutes to about 1 hour.

Usually, the spherical shaped-particles prepared by spray-drying may be easily broken during the firing process. However, in the present invention, the spherical shape can be maintained during the high temperature firing process because the water-soluble polymer acts as a binder. The water-soluble polymer does not, however, remain in the final products but instead is removed by volatilization during the firing process. The supported catalyst synthesized by the method of present invention can accordingly have a substantially spherical shape.

Carbon Nanotubes and Method of Making the Same

The present invention also provides carbon nanotubes synthesized using the supported catalyst and methods of making the same. The supported catalyst of the present invention can be used in a fluidized bed reactor or a fixed bed reactor. A large quantity of carbon nanotubes can be synthesized at one time using a fluidized bed reactor. The supported catalyst of the present invention can be useful in a fluidized bed reactor because the supported catalyst of the present invention has a uniform (even) spherical shape and diameter and thus can perform well (can float well) in the same.

In exemplary embodiments, the carbon nanotubes can be prepared by directing a carbon nanotube precursor material through a reactor including the supported catalyst of the invention under conditions sufficient to prepare carbon nanotubes. For example, the carbon nanotubes can be prepared by injecting a hydrocarbon gas at a temperature of about 650 to about 1100° C., for example about 670 to about 950° C., in the presence of the supported catalyst. In one exemplary embodiment, the carbon nanotubes can be prepared at a temperature of about 650 to about 800° C. In other exemplary embodiments, the carbon nanotubes can be prepared at a temperature of about 800 to about 990° C., and in other exemplary embodiments, the carbon nanotubes can be prepared at a temperature of about 980 to about 1100° C. The hydrocarbon gas may include but is not limited to methane, ethane, acetylene, LPG (Liquefied Petroleum Gas), and the like, and combinations thereof. The hydrocarbon gas can be supplied for about 15 minutes to about 2 hours, for example about 30 to about 60 minutes.

The present invention may be better understood by reference to the following examples which are intended to illustrate the present invention and do not limit the scope of the present invention, which is defined in the claims appended hereto.

### Example 1

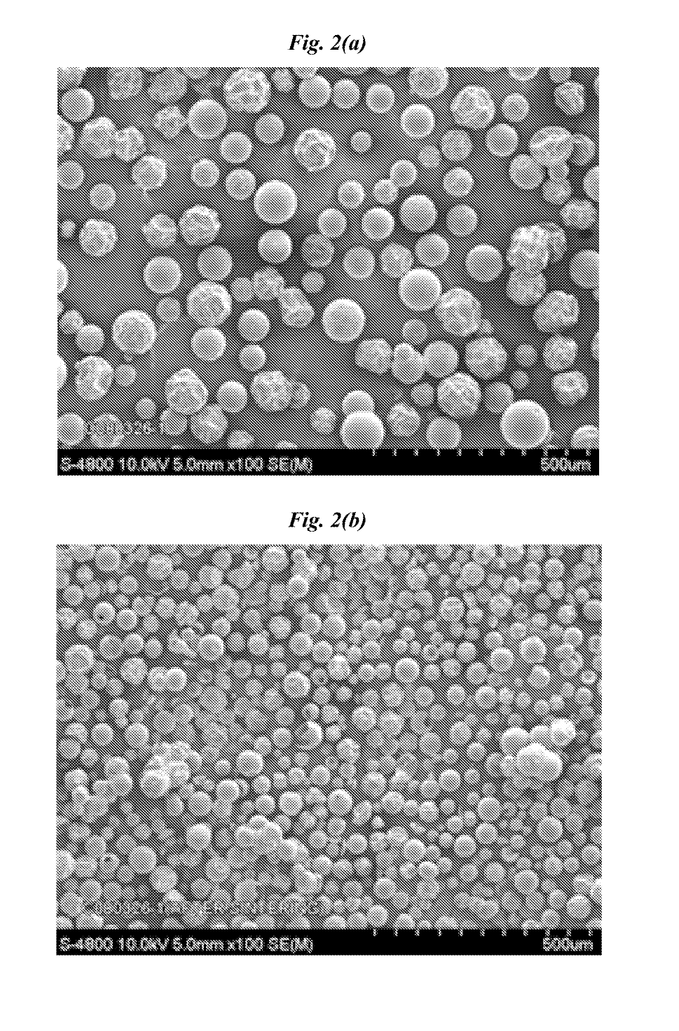

Catalyst powder is prepared by mixing about 20% by weight of polyvinylpyrrolidone (PVP) water-soluble polymer, based on the total weight of solids, with a aqueous catalytic solution comprising Fe, Co, Mo, and Al₂O₃ (Mole ratio of Fe:Co:Mo:Al₂O₃=0.24:0.36:0.02:1.44); spraying the mixture into the interior of a Niro Spray-Dryer (the trade name); and simultaneously drying the sprayed mist using hot air with a temperature of 290° C. FIG. 2(a) is a transmission electron microscope (TEM) image of catalyst particles (powder) prepared at a disc rotating speed of about 8,000 rpm and a solution injection rate of about 30 mL/min.

A supported catalyst is prepared by firing the catalyst particles at a temperature of about 550° C. under normal pressure for 30 minutes in air atmosphere. FIG. 2(b) is a transmission electron microscope (TEM) image of the supported catalyst powder. The metal catalyst maintains a spherical shape despite the heat treatment as shown in FIG. 2(b).

Carbon nanotubes are prepared by directing ethylene and hydrogen gas (1:1 ratio) at a flow rate of 100/100 sccm over about 0.03 g of the supported catalyst for 45 minutes.

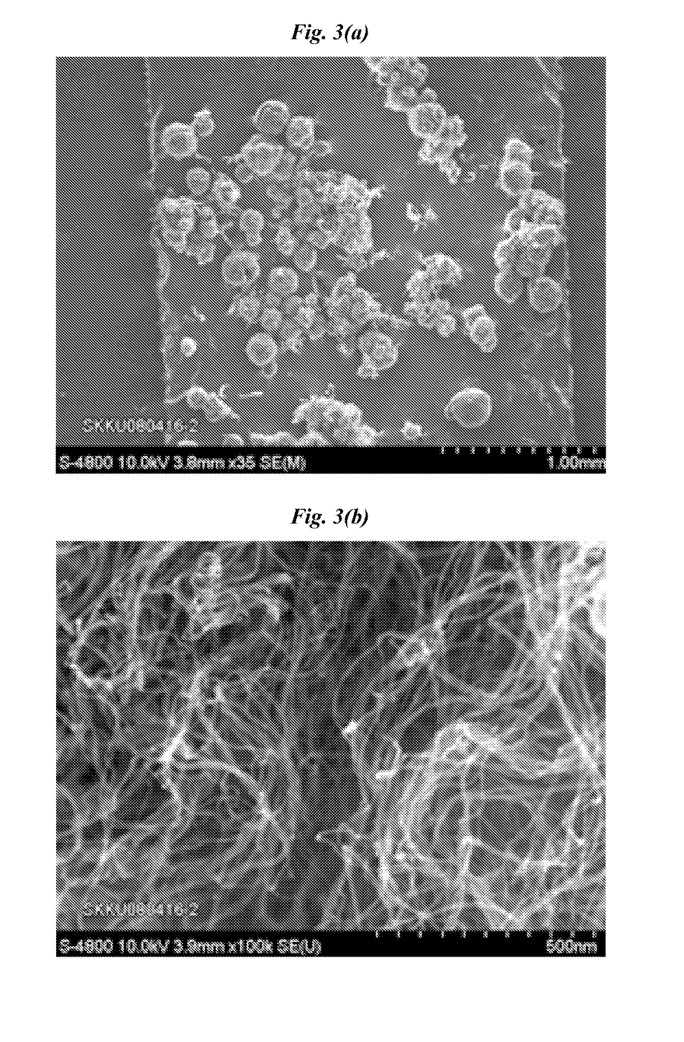

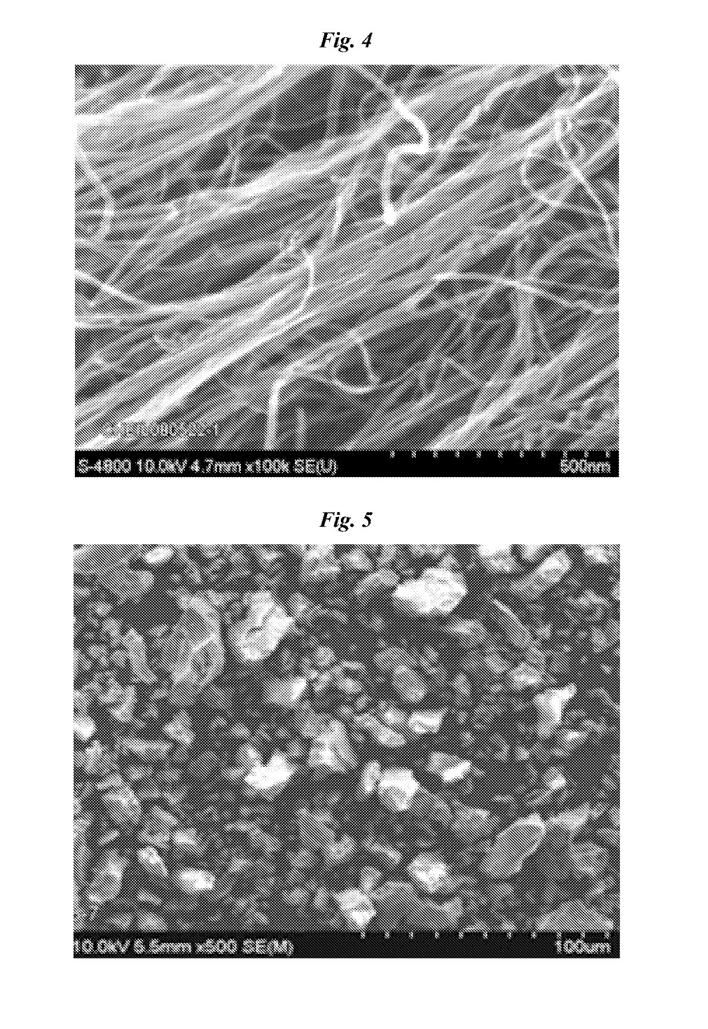

FIGS. 3(a) and (b) are transmission electron microscope (TEM) images of the resultant carbon nanotubes at 35 and 100 magnification, respectively. The prepared carbon nanotubes have an even diameter as shown in FIG. 3.

### Example 2

Example 2 is performed in the same manner as the above Example 1 except that polyvinylalcohol (PVC) is used as the water-soluble polymer. The spherical shape of the prepared supported catalyst is confirmed by transmission electron microscope (TEM) images. Carbon nanotubes are prepared in the same manner as the above Example 1 using the prepared supported catalyst.

The average diameter of the supported catalysts, the yield of carbon nanotubes, and the average diameter of the carbon nanotubes of Examples 1 and 2 are set forth in Table 1.

TABLE 1

| | Example 1 | Example 2 |
|---|---|---|
| Average | 50-70 | 50-70 |
| diameter of | | |
| supported | | |
| catalyst (μm) | | |
| Yield* (%) | 2500 | 3200 |
| Average | 11 | 12 |
| diameter of the | | |
| carbon | | |
| nanotubes (nm) | | |

*Yield: (weight of prepared carbon nanotubes (CNT) − weight of catalyst)/weight of catalyst × 100

### Comparative Example 1

Comparative Example 1 is performed in the same manner as the above Example 1 except the catalyst solution is fired at 550° C. for 30 minutes in air atmosphere without a spray-drying process. FIG. 5 is a transmission electron microscope (TEM) image of the resultant supported catalyst. FIG. 5 illustrates that the supported catalyst did not have a spherical shape, which can be important for use in a fluidized bed reactor.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A supported catalyst for synthesizing carbon nanotubes, comprising:
a metal catalyst comprising Co, Fe, Ni, an alloy thereof, or a combination thereof, supported on a supporting body comprising alumina, magnesium oxide, silica, or a combination thereof; and
a water-soluble polymer,
wherein the supported catalyst has an average diameter of about 30 to about 100 μm.

2. The supported catalyst for synthesizing carbon nanotubes of claim 1, further comprising a molybdenum activator.

3. The supported catalyst for synthesizing carbon nanotubes of claim 2, wherein the supported catalyst has a molar ratio as follows:
Fe, Co, and Ni:Mo:Al, Mg and Si=x:y:z
wherein 1≦x≦10, 0≦y≦5 and 2≦z≦70.

4. The supported catalyst for synthesizing carbon nanotubes of claim 2, wherein the supported catalyst has a molar ratio as follows:
Fe:Co:Mo:Al=x₁:x₂:y:z
wherein 1≦x₁≦20, 5≦x₂≦30, 0.1≦y≦10 and 50≦z≦300.

5. The supported catalyst for synthesizing carbon nanotubes of claim 1, wherein the water-soluble polymer comprises urea based polymer, melamine based polymer, phenol based polymer, unsaturated polyester based polymer, epoxy based polymer, resorcinol based polymer, acetic acid vinyl based polymer, poly vinyl alcohol based polymer, vinyl chloride based polymer, polyvinylacetal based polymer, acrylic based polymer, saturated polyester based polymer, polyamide based polymer, polyethylene based polymer, vinyl based polymer, starch, glue, gelatin, albumin, casein, dextrin, acid modified starch, cellulose, or a combination thereof.

6. The supported catalyst for synthesizing carbon nanotubes of claim 5, wherein the water-soluble polymer comprises polyvinylpyrrolidone (PVP).

7. The supported catalyst for synthesizing carbon nanotubes of claim 5, wherein the water-soluble polymer comprises polyvinylalcohol (PVC).

8. The supported catalyst for synthesizing carbon nanotubes of claim 1, wherein the water-soluble polymer is used in an amount of about 1 to about 50% by weight based on total weight of solids comprising the metal catalysts, the supporting body and the water-soluble polymer.

9. The supported catalyst for synthesizing carbon nanotubes of claim 1, wherein the supported catalyst is hollow.

10. The supported catalyst for synthesizing carbon nanotubes of claim 1, wherein the supported catalyst is spherical.

11. The supported catalyst for synthesizing carbon nanotubes of claim 1, wherein the metal catalyst is in the form of a plurality of metal particles distributed across the outer surface of the supporting body.

12. The supported catalyst for synthesizing carbon nanotubes of claim 10, wherein the metal catalyst is in the form of a plurality of metal particles distributed across the outer and inner surfaces of the supporting body.

13. A method of preparing a supported catalyst for synthesizing carbon nanotubes, comprising the steps of:
mixing a water-soluble polymer and an aqueous catalytic solution comprising metal catalyst and a supporting body to prepare a mixed catalytic solution;
spray-drying the mixed catalytic solution to prepare a catalyst powder; and
firing the catalyst powder.

14. The method of claim 13, wherein the metal catalyst comprises Fe(NO₃)₃, Co(NO₃)₂, Ni(NO₃)₂, Fe(OAc)₂, Ni(OAc)₂, Co(OAc)₂, or a combination thereof.

15. The method of claim 13, wherein the supporting body comprises aluminum nitrate, magnesium nitrate, silicon dioxide, or a combination thereof.

16. The method of claim 13, wherein the water-soluble polymer comprises urea based polymer, melamine based polymer, phenol based polymer, unsaturated polyester based polymer, epoxy based polymer, resorcinol based polymer, acetic acid vinyl based polymer, poly vinyl alcohol based polymer, vinyl chloride based polymer, polyvinylacetal based polymer, acrylic based polymer, saturated polyester based polymer, polyamide based polymer, polyethylene based polymer, vinyl based polymer, starch, glue, gelatin, albumin, casein, dextrin, acid modified starch, cellulose, or a combination thereof.

17. The method of claim 16, wherein the water-soluble polymer comprises polyvinylpyrrolidone (PVP).

18. The method of claim 16, wherein the water-soluble polymer comprises polyvinylalcohol (PVC).

19. The method of claim 13, wherein the water-soluble polymer is used in amount of about 1 to about 50% by weight based on the total weight of the solids in the aqueous catalytic solution.

20. The method of claim 13, wherein the aqueous catalytic solution further include a molybdenum activator.

21. The method of claim 13, wherein the spray-drying is performed at a disc rotation rate of about 5,000 to about 20,000 rpm and a solution injection rate of about 15 to about 100 mL/min.

22. The method of claim 13, wherein the spray-drying step forms spherical shaped catalyst powder, and wherein the firing steps maintains the spherical shape of the catalyst powder to a form a spherical supported catalyst.

23. A method of making carbon nanotubes, comprising directing a carbon nanotube precursor material through a reactor including a supported catalyst of claim 1 under conditions sufficient to produce the carbon nanotubes

24. The method of claim 23, wherein the reactor is a fluidized bed reactor.

25. The method of claim 23, wherein the carbon nanotube precursor material comprises hydrocarbon gas and wherein the step of directing the carbon nanotube precursor material through a reactor comprises directing the hydrocarbon gases through the reactor at a temperature of about 650 to about 1100° C. in the presence of the supported catalyst.
